(19) United States
(12) Patent Application Publication
(10) Pub. No.: US 2022/0153919 A1
(43) Pub. Date: May 19, 2022

(54) SILICONE HYBRID RESIN COMPOSITION AND SEMICONDUCTOR DEVICE

(71) Applicant: SHIN-ETSU CHEMICAL CO., LTD., Tokyo (JP)

(72) Inventors: Tomoyuki MIZUNASHI, Annaka-shi (JP); Naoyuki KUSHIHARA, Annaka-shi (JP)

(73) Assignee: SHIN-ETSU CHEMICAL CO., LTD., Tokyo (JP)

(21) Appl. No.: 17/527,507

(22) Filed: Nov. 16, 2021

(30) Foreign Application Priority Data
Nov. 18, 2020 (JP) 2020-191827

(51) Int. Cl. C08G 59/20; C08G 77/38; C08G 59/50; C08G 59/42; C08K 5/00; C08K 5/50

(52) U.S. Cl. CPC C08G 59/20; C08G 77/38; C08K 5/50; C08G 59/4215; C08K 5/0025; C08G 59/5033

(57) ABSTRACT

A silicone hybrid resin composition contains: (A) 100 parts by mass of a curable organic resin composition containing (A1) one or more curable organic resins selected from an epoxy resin, an acrylic resin, a polyimide resin, a maleimide resin, a polyurethane resin, a phenolic resin, a melamine resin, and silicone-modified resins thereof; and (B) 1 to 300 parts by mass of a curable silicone resin composition having a viscosity at 25° C. of 0.01 to 1,000 Pa·s as measured by a method described in JIS K 7117-1:1999, where the component (B) is a dispersion in the component (A), and the component (A) is a curable organic resin composition that cures by a reaction mechanism that is different from a reaction mechanism of the component (B). The silicone hybrid resin composition can lower a storage modulus and is excellent in adhesiveness to a substrate while maintaining the Tg of an organic resin.

### TECHNICAL FIELD

The present invention relates to: a silicone hybrid resin composition; and a semiconductor device.

### BACKGROUND ART

As resin materials used in electronic and electric components, organic resin compositions such as epoxy resins excellent in mechanical properties, electric properties, heat resistance, and adhesive properties are widely used.

However, with miniaturization and thinning of packages of electronic components in recent years, there is a problem that organic resins before now have a high modulus of elasticity, so that the stress applied to surrounding members is high, and cracking of the packages or delamination from a substrate occur during a thermal shock test. To solve this problem, composite materials obtained by making a silicone resin homogeneously compatible in an epoxy resin and epoxy-silicone hybrid resins obtained by modifying a silicone material with an epoxy group have been developed, for example, for the purpose of achieving a low modulus of elasticity (Patent Documents 1, 2, and 3). However, although such materials can lower the modulus of elasticity by the silicone component being taken into the epoxy resin skeleton, there is a problem that a glass-transition temperature (Tg) also becomes lowered.

In addition, there have been proposed methods for lowering the stress applied to packages of electronic components by adding rubber particles such as an acrylic powder or a silicone powder to an organic resin to lower the modulus of elasticity of the resin (Patent Documents 4 and 5).

According to this method, it becomes possible to achieve a low modulus of elasticity while maintaining the Tg. However, these rubber particles have the surface coated with alkoxysilane, nanoparticles, or the like to prevent the particles from cohering with each other. Therefore, there are many components other than the rubber particles, and there is a problem that viscosity is remarkably increased when the rubber particles are added to a resin, degrading workability.

### CITATION LIST

### Patent Literature

Patent Document 1: JP 2006-104483 A
Patent Document 2: JP 2016-084373 A
Patent Document 3: JP 2020-23643 A
Patent Document 4: JP 2014-84332 A
Patent Document 5: JP 2017-115132 A

### SUMMARY OF INVENTION

### Technical Problem

The present invention has been made in view of the above-described problems, and an object thereof is to provide a silicone hybrid resin composition that can lower a storage modulus and is excellent in adhesiveness to a substrate while maintaining the Tg of an organic resin.

### Solution to Problem

To solve the above problems, the present invention provides a silicone hybrid resin composition comprising:

(A) 100 parts by mass of a curable organic resin composition comprising (A1) one or more curable organic resins selected from a group consisting of an epoxy resin, an acrylic resin, a polyimide resin, a maleimide resin, a polyurethane resin, a phenolic resin, a melamine resin, and silicone-modified resins thereof; and

(B) 1 to 300 parts by mass of a curable silicone resin composition having a viscosity at 25° C. of 0.01 to 1,000 Pa·s as measured by a method described in JIS K 7117-1:1999,

wherein the component (B) is a dispersion in the component (A), and the component (A) is a curable organic resin composition that cures by a reaction mechanism that is different from a reaction mechanism of the component (B).

The inventive silicone hybrid resin composition has a high Tg, low elasticity, and can give a cured material excellent in adhesiveness.

Furthermore, the component (B) preferably has a domain size of 100 μm or less.

When the component (B) has such a domain size, the component (A) and the component (B) do not become easily separated.

Furthermore, the component (B) is preferably a curable silicone resin composition selected from an addition-curable silicone resin composition, a condensation-curable silicone resin composition, and a radical-curable silicone resin composition.

With such a component (B), the curability of the silicone hybrid resin composition becomes favorable.

In addition, the component (A1) is preferably an epoxy resin and/or a silicone-modified epoxy resin.

With such a component (A1), it is easy to control the reaction, handleability of the resin is favorable, and the curability of the component (B) is not easily affected. In addition, dispersibility of the component (B) can be improved by using an epoxy resin and a silicone-modified epoxy resin in combination.

The inventive composition preferably further comprises (C) 0.001 to 10 parts by mass of a curing accelerator of the component (A).

When such a component (C) is contained, the component (A) cures favorably.

The component (A) preferably further comprises (A2) a curing agent of the component (A1) in an amount such that there are, based on a total of 1 equivalent of a curing-reactive group in the component (A1), 0.3 to 2.0 equivalents of a group in the component (A2), the group having reactivity to the curing-reactive group.

The component (A) also cures favorably when such a component (A2) is contained.

In addition, the component (B) preferably cures before the component (A).

With such a component (B), the storage modulus can be lowered while maintaining the Tg, and a resin composition that also has favorable adhesiveness to a substrate can be achieved.

The present invention further provides a semiconductor device comprising a cured material of the above-described silicone hybrid resin composition.

The cured material of the silicone hybrid resin composition of such a semiconductor device has low elasticity, and therefore, the stress applied to packages of electronic components does not become high.

### Advantageous Effects of Invention

As described above, the inventive silicone hybrid resin composition has good workability, a high Tg, low elasticity, thermal shock resistance, and can give a cured material excellent in adhesiveness.

### DESCRIPTION OF EMBODIMENTS

As described above, a silicone hybrid resin composition that can lower a storage modulus while maintaining the Tg of an organic resin and is excellent in adhesiveness to a substrate has been desired.

The present inventors have earnestly studied to solve the above-described problems, and found out the following. Low elasticity can be achieved while maintaining the Tg of the organic resin by using a silicone hybrid resin composition in which a curable silicone resin composition is a dispersion in a curable organic resin composition, and the curable organic resin composition cures by a reaction mechanism different from that of the curable silicone resin composition. Thus, the present invention has been achieved.

That is, the present invention is a silicone hybrid resin composition comprising:

(A) 100 parts by mass of a curable organic resin composition comprising (A1) one or more curable organic resins selected from a group consisting of an epoxy resin, an acrylic resin, a polyimide resin, a maleimide resin, a polyurethane resin, a phenolic resin, a melamine resin, and silicone-modified resins thereof; and

(B) 1 to 300 parts by mass of a curable silicone resin composition having a viscosity at 25° C. of 0.01 to 1,000 Pa·s as measured by a method described in JIS K 7117-1:1999,

wherein the component (B) is a dispersion in the component (A), and the component (A) is a curable organic resin composition that cures by a reaction mechanism that is different from a reaction mechanism of the component (B).

Hereinafter, the present invention will be described in detail, but the present invention is not limited thereto.

### [(A) Curable Organic Resin Composition]

The component (A) is a curable organic resin composition that contains, as an essential component, one or more curable organic resins (A1) selected from a polyurethane resin, a phenolic resin, an epoxy resin, an acrylic resin, a melamine resin, a polyimide resin, a maleimide resin, and silicone-modified resins thereof.

As the curable organic resin composition, a known composition can be used, and the component (A) has a characteristic of being a curable organic resin composition that cures by a reaction mechanism different from that of the component (B) described below. In particular, a curable organic resin composition containing an epoxy resin, a silicone-modified epoxy resin, a polyimide resin, or a maleimide resin, which allow easy control of the reaction and favorable handleability of the resin are favorable, and furthermore, a curable organic resin composition that contains an epoxy resin or a silicone-modified epoxy resin, which do not easily affect the curability of the curable silicone resin composition (B) described below are particularly preferable.

Specific examples of the epoxy resin include an epoxy resin of triazine derivative, an isocyanurate type epoxy resin, a bisphenol A type epoxy resin, a bisphenol F type epoxy resin, a biphenyl type epoxy resin, a novolak type epoxy resin, an alicyclic epoxy resin, a cyclic aliphatic epoxy resin, a fluorene type epoxy resin, a naphthalene-containing epoxy resin, an aminophenol type epoxy resin, a hydrogenated bisphenol type epoxy resin, an ether-based or a polyether-based epoxy resin, an oxirane-ring-containing polybutadiene, a silicone-modified epoxy resin, and the like, and an isocyanurate type epoxy resin, a bisphenol A type epoxy resin, a novolak type epoxy resin, an alicyclic epoxy resin, and a silicone-modified epoxy resin are preferable. One of these resins may be used, or two or more thereof may be used in combination.

A silicone-modified epoxy resin is preferable since it is possible to improve the dispersibility of the components (A) and (B) by functioning as a dispersing agent with the following component (B) curable silicone resin composition when the silicone-modified epoxy resin is used in combination with other epoxy resins.

### [(B) Curable Silicone Resin Composition]

The component (B) is a curable silicone resin composition having a viscosity at 25° C. of 0.01 to 1,000 Pa·s as measured by a method described in JIS K 7117-1:1999. As the curable silicone resin composition, a known composition can be used. Specific examples thereof include addition-curable (hydrosilylation-reactive), condensation-curable (condensation-reactive), and radical-curable (photo- and thermal-radical-reactive) silicone resin compositions, for example, an organopolysiloxane composition, etc.

Here, the component (B) has a characteristic of being a curable silicone resin composition that cures by a reaction mechanism different from that of the component (A). Hereinafter, the component (B) will be described in detail, and in addition, preferable combinations of the component (A) and the component (B) will also be described.

Note that resins obtained by silicone-modifying organic resins such as those exemplified in the curable organic resin composition (A) are preferably not contained as the component (B).

As the thermal-radical-curable silicone resin composition, for example, it is possible to use a silicone composition that cures by subjecting a linear or branched organopolysiloxane to radical polymerization in the presence of an organic peroxide, the organopolysiloxane having an alkenyl group such as a vinyl group on one or both of the non-terminal area of the molecular chain and terminals of the molecular chain (one terminal or both terminals).

Examples of the photo-radical-curable silicone resin composition include ultraviolet-curable silicone resin compositions and electron-beam-curable silicone resin compositions.

Examples of the ultraviolet-curable silicone resin compositions include silicone resin compositions that cure by the energy of an ultraviolet ray with a wavelength of 200 to 400 nm. In this case, the curing mechanism is not particularly restricted. Specific examples thereof include: an acryl-silicone based silicone resin composition containing an organopolysiloxane having an acrylic group or a methacrylic group and a photopolymerization initiator; a mercapto-vinyl addition polymerization type silicone resin composition containing a mercapto-group-containing organopolysiloxane, an organopolysiloxane having an alkenyl group such as a vinyl group, and a photopolymerization initiator; an addition reaction type silicone resin composition that uses the same platinum group metal-based catalyst of the addition reaction type as that of a thermal curable composition; a cation polymerization type silicone resin composition containing an organopolysiloxane containing an epoxy group and an onium salt catalyst; and the like. Any of these can be used as an ultraviolet-curable silicone resin composition.

As an electron-beam-curable silicone resin composition, it is possible to use any silicone resin composition that cures by radical polymerization that is initiated by irradiating an organopolysiloxane having a radical polymerizable group with an electron beam.

Examples of the component (A1) favorable for these radical-curable silicone resin compositions include an epoxy resin and a polyimide resin.

If a component (A) of the same radical-curable type is used for the radical-curable silicone resin composition, the component (A) and the component (B) cure at the same time, and the component (A) becomes taken into the resin skeleton of the component (B). Therefore, there is risk of the Tg of the silicone hybrid resin composition being lowered.

As an addition-curable silicone resin composition, for example, it is possible to use a silicone resin composition that cures by making an organopolysiloxane having the above alkenyl group and an organohydrogenpolysiloxane react (hydrosilylation reaction) in the presence of a platinum group metal-based catalyst.

As the catalyst for promoting a hydrosilylation reaction, any conventionally known catalyst can be used. Considering cost, etc., examples include platinum-based catalysts such as platinum, platinum black, and chloroplatinic acid, for example, H₂PtCl₆·pH₂O, K₂PtCl₆, KHPtCl₆·pH₂O, K₂PtCl₄, K₂PtCl₄·pH₂O, PtO₂·pH₂O, PtCl₄·pH₂O, PtCl₂, H₂PtCl₄·pH₂O (where “p” is a positive integer), etc., a complex of these and a hydrocarbon such as such as an olefin, an alcohol, or a vinyl-group-containing organopolysiloxane, a complex having light-activity such as a trimethyl(methylcyclopentadienyl)platinum, etc. One of these catalysts may be used, or a combination of two or more thereof may be used. The amount of these catalysts to be blended can be an effective amount for curing, and is normally 0.1 to 500 ppm in terms of mass as a platinum group metal based on the total amount of the component (B), particularly preferably 0.5 to 100 ppm.

Examples of the component (A1) favorable for the addition-curable silicone resin composition include an epoxy resin, an acrylic resin, and a maleimide resin.

A polyimide resin can also be used as the component (A1), and when there are few amino groups remaining in the polyimide resin, amino groups do not inhibit curing of the addition-curable silicone resin composition, and the component (B) cures sufficiently.

Meanwhile, when an amine compound is used as the curing agent (A2) described below, an addition-curable silicone resin composition of the component (B) can be dispersed in the component (A) excluding the amine compound, the component (B) alone can be cured in the system, and then the amine compound can be added. In this manner, it is possible to obtain a silicone hybrid resin composition containing an amine compound without inhibiting the curing of the addition-curable silicone resin composition.

As the condensation-curable silicone resin composition, it is possible to use, for example, a silicone resin composition that cures by a reaction between an organopolysiloxane having both terminals capped with silanol and a hydrolysable silane such as an organohydrogenpolysiloxane or a tetraalkoxysilane, organotrialkoxysilane, etc. and/or a partial hydrolysis condensate thereof in the presence of a condensation reaction catalyst such as an organic tin-based catalyst; or a silicone resin composition that cures by a reaction of an organopolysiloxane having both terminals capped with a trialkoxy group, a dialkoxyorgano group, a trialkoxysiloxyethyl group, a dialkoxyorganosiloxyethyl group, or the like in the presence of a condensation reaction catalyst such as a metal alkoxide catalyst, an amine catalyst, an organometallic catalyst, or the like.

Examples of the component (A1) favorable for these condensation-curable silicones include an epoxy resin, a polyimide resin, an acrylic resin, a maleimide resin, etc.

The refractive index of the curable silicone resin composition is not particularly limited, and can be appropriately adjusted by a substituent bonded to a silicon atom. The refractive index of the curable silicone resin composition (curable organic silicon resin composition) is preferably 1.30 to 1.65, further preferably 1.40 to 1.58.

Within these ranges, properties of the curable silicone resin composition can be sufficiently exhibited, and it is possible to adjust the transparency and reflectance of the silicone hybrid resin composition by a combination with an organic resin composition.

As the viscosity of the curable silicone resin composition, the viscosity measured with a rotational viscometer described in JIS K 7117-1:1999 at 25° C. is 0.01 to 1,000 Pa-s, preferably 0.1 to 100 Pa-s.

If the viscosity is below this viscosity range, droplets easily combine with each other when mixed with an organic resin composition, so that there is risk of it becoming difficult to mix the composition homogeneously. If the viscosity is above this viscosity range, there is risk of the viscosity becoming so high that it becomes difficult to handle the composition.

In addition, (B) the curable silicone resin composition has a characteristic of being a dispersion in the component (A), and preferably has a domain size of 100 μm or less, more preferably 0.1 to 20 μm.

Note that in the present invention, “domain size” refers to the maximum size measured in the following manner. A cured material of the inventive silicone hybrid resin composition is fabricated, and the cross section thereof is observed by using a digital microscope and an electron microscope while appropriately adjusting the magnification in accordance with the size of the domain. The maximum size is extracted from at least 100 domains by image processing, and then measured.

When the component (B) is a dispersion in the component (A) and each component employs a different curing mechanism, the component (B) alone can be selectively cured. In this manner, the viscosity and flow of the resin can be appropriately adjusted at a favorable time. In addition, the composition can be provided with low elasticity without adversely affecting the curability of the component (A) regardless of whether or not the component (B) has cured. If a component that does not disperse and becomes completely compatible is used, there is risk that the composition itself gelates when the component (B) is cured and becomes impossible to use, and when the modulus of elasticity is lowered, the Tg sometimes also becomes lowered at the same time, even if the curing mechanism of the component (A) and the component (B) are different.

In addition, if the curing mechanism of the component (A) and the component (B) are the same, the component (B) is taken into the skeleton of the component (A), and therefore, there is a risk that the Tg becomes lowered.

The component (B) is 1 to 300 parts by mass relative to 100 parts by mass of the component (A).

### [(C) Curing Accelerator]

As the curing accelerator of the component (A), a known curing accelerator can be used. The curing accelerator of the organic resin composition varies depending on the type of the organic resin composition, but is not particularly restricted as long as the curing accelerator promotes a curing reaction. Examples of the curing accelerator include alkoxides or carboxylate complexes of lead, tin, zinc, iron, zirconium, titanium, cerium, calcium, and barium; metal compounds including silicates of alkaline metal such as lithium silicate, sodium silicate, and potassium silicate; phosphorous-based compounds such as triphenylphosphine, tributylphosphine, tri(p-methylphenyl)phosphine, tri(nonylphenyl)phosphine, triphenylphosphine·triphenylborane, and tetraphenylphosphine·tetraphenylborate; tertiary amine compounds such as triethylamine, benzyldimethylamine, α-methylbenzyldimethylamine, and 1,8-diazabicyclo [5.4.0]undecene-7; imidazole compounds such as 2-methylimidazole and 2-phenyl-4-methylimidazole; photo cation curing catalysts such as triarylsulfonium hexafluorophosphate and triphenylsulfonium hexafluorophosphate; and thermal- and photo-radical initiators such as dicumyl peroxide, n-butyl-4,4′-bis(butylperoxy)valerate, 1,1-bis(t-butylperoxy)-3,3,5-trimethylcyclohexane, di-t-butyl peroxide, 2,5-di-(t-butylperoxy)-2,5-dimethylhexane, 1,1-bis(tert-amylperoxy)cyclohexane, 2,2-bis(tert-butylperoxy)butane, 2,4-pentanedione peroxide, 2,5-bis(tert-butylperoxy)-2,5-dimethylhexane, 2,5-di(tert-butylperoxy)-2,5-dimethyl-3-hexyne, 2-butanone peroxide, benzoyl peroxide, cumenehydro peroxide, di-tert-amyl peroxide, lauroyl peroxide, tert-butylhydro peroxide, tert-butylperacetate, tert-butylperoxy benzoate, tert-butylperoxy-2-ethylhexyl carbonate, di(2,4-dichlorobenzoyl) peroxide, dichlorobenzoyl peroxide, di(tert-butylperoxyisopropyl)benzene, di(4-methylbenzoyl) peroxide, butyl-4,4-di(tert-butylperoxy)valerate, 3,3,5,7,7-pentamethyl-1,2,4-trioxepane, tert-butylperoxy-3,5,5-trimethylhexanoate, tert-butylcumyl peroxide, di(4-tert-butylcyclohexyl)peroxydicarbonate, dicetylperoxydicarbonate, dimyristylperoxydicarbonate, 2,3-dimethyl-2,3-diphenylbutanedioctanoyl peroxide, tert-butylperoxy-2-ethylhexyl carbonate, tert-amylperoxy-2-ethylhexanoate, and tert-amylperoxy pivalate.

The amount of the curing accelerator to be added is preferably 0.001 to 10 parts by mass, more preferably 0.02 to 5 parts by mass, and further preferably 0.05 to 3 parts by mass based on 100 parts by mass of the component (A)

### [(A2) Curing Agent]

The curable organic resin composition of the component (A) can be cured in the presence of (C) the curing accelerator, but it is also possible to add, as the component (A2), a curing agent of the component (A1) in addition to (A1) the curable organic resin. For example, as a curing agent of the above-described epoxy resins, it is possible to use, for example, a phenol-based curing agent, an acid-anhydride-based curing agent, an amine-based curing agent, or a mercaptan-based curing agent.

The curing agent may be blended at the same time as the components (A1), (B), and (C). Alternatively, it is possible to blend the components (A1), (B), and (C), cure the component (B), and then blend the component (A2) thereafter. The component (A2) is preferably blended in an amount such that there are, based on a total of 1 equivalent of a curing-reactive group in the component (A1), 0.3 to 2.0 equivalents of a group in the component (A2), the group having reactivity to the curing-reactive group.

Examples of the phenol-based curing agent include a phenol novolak resin, a cresol novolak resin, a naphthol-modified phenolic resin, a dicyclopentadiene-modified phenolic resin, a bisphenol A type resin, a bisphenol F type resin, a biphenyl type phenolic resin, and the like, but are not limited thereto. One of these may be used, or two or more thereof may be used in combination.

The ratio of the blended epoxy resin and phenolic resin is preferably 0.3 to 1.8 equivalents, further preferably 0.5 to 1.5 equivalents of the phenolic hydroxy group equivalent in the phenolic resin to 1 equivalent of the epoxy group in the epoxy resin.

Examples of the acid-anhydride-based curing agent include a methyltetrahydrophthalic anhydride, a methylhexahydrophthalic anhydride, an alkylated tetrahydrophthalic anhydride, a hexahydrophthalic anhydride, a methylhimic anhydride, a dodecenylsuccinic anhydride, a methylnadic anhydride, and the like, but are not limited thereto. One of these may be used, or two or more thereof may be used in combination.

The ratio of the blended epoxy resin and acid anhydride is preferably 0.5 to 1.5 equivalents, further preferably 0.6 to 1.2 equivalents of the acid anhydride equivalents to 1 equivalent of the epoxy group in the epoxy resin.

Examples of the amine-based curing agent include aliphatic polyamines; aromatic amines; and modified polyamines such as a polyaminoamide, a polyaminoimide, a polyaminoester, and a polyaminourea. In addition, a tertiary-amine-based, an imidazole-based, a hydrazide-based, a dicyanediamide-based, and a melamine-based compound can also be used. However, the amine-based curing agent is not limited thereto. One of these may be used, or two or more thereof may be used in combination.

The ratio of the blended epoxy resin and amine-based compound is preferably 0.5 to 1.5 equivalents, further preferably 0.6 to 1.2 equivalents of the amine equivalents to 1 equivalent of the epoxy group in the epoxy resin.

Examples of the mercaptan-based curing agent include trimethylolpropanetris(3-mercaptobutyrate), trimethylolethanetris(3-mercaptobutyrate), and the like, but are not limited thereto. One of these may be used, or two or more thereof may be used in combination.

The ratio of the blended epoxy resin and mercaptan-based compound is preferably 0.3 to 1.8 equivalents, further preferably 0.5 to 1.5 equivalents of the mercapto equivalents to 1 equivalent of the epoxy group in the epoxy resin.

### [Other Additives]

Examples of other additives include reinforcing inorganic fillers such as silica, glass fiber, and fumed silica; inorganic white pigments such as titanium dioxide, zinc oxide, zirconium oxide, calcium carbonate, magnesium oxide, aluminum hydroxide, barium carbonate, magnesium silicate, zinc sulfate, and barium sulfate; non-reinforcing inorganic fillers such as calcium silicate, carbon black, cerium fatty acid salt, barium fatty acid salt, cerium alkoxide, and barium alkoxide; and fillers such as silver (Ag), aluminum (A1), aluminum nitride (AlN), boron nitride (BN), silicon dioxide (silica: SiO₂), aluminum oxide (alumina: Al₂O₃), iron oxide (Fe₂O₃), tri-iron tetroxide (Fe₃O₄), lead oxide (PbO₂), tin oxide (SnO₂), cerium oxide (Ce₂O₃, CeO₂), calcium oxide (CaO), tri-manganese tetroxide (Mn₃O₄), and barium oxide (BaO). These can be blended appropriately in an amount of 600 parts by mass or less, preferably 10 to 400 parts by mass for a total of 100 parts by mass of the components (A) to (C).

### [Method for Manufacturing Silicone Hybrid Resin Composition]

The inventive silicone hybrid resin composition can be manufactured by the method described below, for example.

For example, (A) a curable organic resin composition, (B) a curable silicone resin composition, and (C) a curing accelerator can be mixed, stirred, and dissolved and/or dispersed at the same time or separately, in some cases while performing a heat treatment or a light irradiation treatment, to obtain a mixture. Manufacturing apparatuses for such mixing, stirring, dispersing, etc. are not particularly limited, and it is possible to use a kneader, a triple roll mill, a ball mill, a planetary mixer, a planetary centrifugal mixer, a bead mill, an ultrasonic mixer, a resonance mixer, a high-speed revolution mixer, or the like equipped with stirring and heating equipment. In addition, these apparatuses can also be used appropriately in combination.

In the silicone hybrid resin composition manufactured by the above method, the component (A) and the component (B) do not become homogeneously compatible and are mixed with a domain of at least 100 μm or less, regardless of the mixing method. The domain of the component (A) and the component (B) in the silicone hybrid resin composition is preferably 100 μm or less. When the domain is 100 μm or less, the component (A) and the component (B) do not easily separate, so that the material properties can be exhibited sufficiently.

### [Method for Curing Silicone Hybrid Resin Composition]

The inventive silicone hybrid resin composition can be applied to a predetermined substrate according to use, and then cured. Regarding curing conditions, the composition cures sufficiently at a normal temperature (25° C.), but it is also possible to cure the composition by heating or light irradiation as necessary. When heating, the curing can be performed at a temperature of 60 to 200° C., for example. When irradiating with light, the curing can be performed by the energy of an ultraviolet ray with a wavelength of 200 to 400 nm, for example.

From the viewpoint of reducing the storage modulus while maintaining the Tg and obtaining a resin composition that also has favorable adhesiveness to a substrate, the component (B) preferably cures before the component (A).

In the inventive silicone hybrid resin composition, the component (A), the component (B), and the component (C) may be mixed and then used. Alternatively, the component (B) alone can be cured with at least the component (A) and the component (B) mixed and the component (C) can be added thereafter to make a cured material of the (B) disperse in the component (A) and the component (C). In particular, in a case where the curing accelerator of the component (C) inhibits the curing of the component (B) and so forth, a method of curing the component (B) before adding the component (C) is preferable.

Regarding the curing conditions when the component (B) alone is cured, the component (B) alone can be cured by heating at a temperature of, for example, 60 to 200° C. or by the energy of an ultraviolet ray with a wavelength of 200 to 400 nm in a state where the component (B) is dispersed in the component (A). Subsequently, the component (C) can be added to obtain a silicone hybrid resin composition in which only the component (B) has cured. As an alternative, the reaction mechanism of the mixture of the component (A), the component (B), and the component (C) can be changed. In this manner, it is possible to cure only the component (B) by heating and light irradiation even after mixing the component (A), the component (B), and the component (C).

Such a silicone hybrid resin composition of the present invention can give a cured material that has a high Tg and excellent thermal shock resistance and adhesive properties.

### [Uses for Silicone Hybrid Resin Composition]

The inventive silicone hybrid resin composition can be used for various uses such as encapsulants, adhesives, electric insulating materials, laminated plates, coating, ink, paint, sealant, resists, composite materials, films, underfill materials, antireflective materials, light-diffusing materials, and light-reflecting materials, for example, but is not limited thereto.

In addition, the present invention provides a semiconductor device including a cured material of the above-described silicone hybrid resin composition. The inventive semiconductor device is, for example, a semiconductor device in which a semiconductor element is encapsulated by a cured material of the above-described silicone hybrid composition of the present invention.

### EXAMPLE

Hereinafter, the present invention will be specifically described with reference to Examples and Comparative Examples, but the present invention is not limited thereto. Note that “parts” indicate “parts by mass”, and the viscosity of each component indicates the viscosity measured at 25° C. measured with a rotational viscometer described in JIS K 7117-1:1999.

The components shown in Table 1 will be described below.

(A1) Curable organic resin

### (A-1)

Epoxy resin: trade name “JER-828EL” [bisphenol A type epoxy resin], manufactured by Mitsubishi Chemical Corporation. 10,000 mPa·s.

### (A-2)

Epoxy resin: trade name “TEPIC-S” [isocyanurate type epoxy resin], manufactured by Nissan Chemical Industries, Ltd. Solid at normal temperature.

### (A-3)

Silicone-modified epoxy resin: the silicone-modified epoxy resin shown by the following formula, manufactured by Shin-Etsu Chemical Co., Ltd. 18,000 mPa·s.

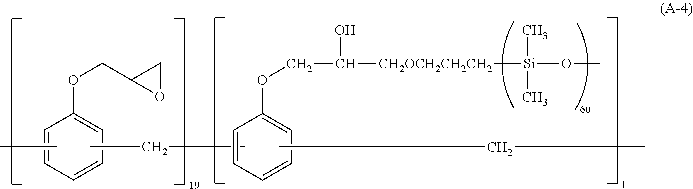

Epoxy resin: trade name “THI-DE” [alicyclic epoxy resin], manufactured by JXTG Nippon Oil & Energy Corporation. 20 mPa·s.

### (A-5)

Polyimide resin: trade name “KJR-657” [polyimide resin], manufactured by Shin-Etsu Chemical Co., Ltd. 1,000 mPa·s.

### (A-6)

Acrylic resin: trade name “LIGHT ACRYLATE BP-4EAL” [bisphenol A type diacrylate resin], manufactured by Kyoeisha Chemical Co., Ltd. 1200 mPa·s.

(B) Curable silicone resin composition and silicone rubber particles

### (B-1)

Hydrosilylation-curable silicone resin composition: trade name “LPS-3450/C-3450” [methylsilicone resin containing a polyorganosiloxane], manufactured by Shin-Etsu Chemical Co., Ltd., containing a hydrosilylation catalyst. A mixed product of LPS-3450 and C-3450 at 5:1. A viscosity of 3,500 mPa·s, a refractive index of 1.41, and hardness type A50.

### (B-2)

Hydrosilylation-curable silicone resin composition: trade name “LPS-3620A/LPS-3620B” [phenylmethyl silicone resin containing a polyorganosiloxane], manufactured by Shin-Etsu Chemical Co., Ltd., containing a hydrosilylation catalyst. A mixed product of LPS-3620A and LPS-3620B at 1:1. A viscosity of 12,500 mPa·s, a refractive index of 1.50, and hardness type A75.

### (B-3)

Photo-radical-curable silicone resin composition: trade name “KJC-7805T-3” [UV-curable silicone resin containing an acrylic-modified polyorganosiloxane], manufactured by Shin-Etsu Chemical Co., Ltd., containing a photopolymerization initiator. A viscosity of 3,500 mPa·s, a refractive index of 1.44, and hardness type A50.

### (B-4)

Condensation-curable silicone resin composition: trade name “LPS-9417/C-9417” [methyl silicone resin containing a polyorganosiloxane], manufactured by Shin-Etsu Chemical Co., Ltd., containing a condensation catalyst. A mixed product of LPS-9417 and C-9417 at 10:1. A viscosity of 23,000 mPa·s, a refractive index of 1.41, and hardness type A80.

### (B-5)

Silicone rubber particles: trade name “KMP-600”, manufactured by Shin-Etsu Chemical Co., Ltd.

### (B-6)

Epoxy-modified silicone resin: epoxy-modified silicone resin, manufactured by Shin-Etsu Chemical Co., Ltd. A viscosity of 16,000 mPa·s.

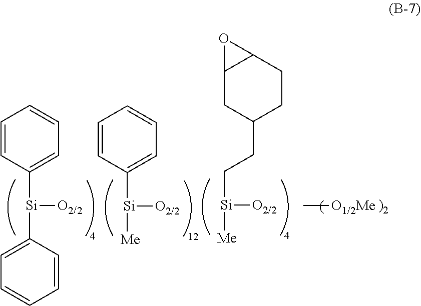

Photohydrosilylation-curable silicone resin composition: trade name “X-35-501” [methyl silicone resin containing a polyorganosiloxane], manufactured by Shin-Etsu Chemical Co., Ltd., containing a light-activated hydrosilylation catalyst. A viscosity of 5,000 mPa·s, a refractive index of 1.41, and hardness type A80.

### (C) Curing Accelerator

### (C-1)

Phosphorous-based curing accelerator: trade name “U-CAT-5003” [quaternary phosphonium bromide], manufactured by San-Apro Ltd.

### (C-2)

Photo cation curing accelerator: trade name “SPI-210S” [triarylsulfonium-phosphorous-based anion salt], manufactured by San-Apro Ltd.

### (C-3)

Zinc-based curing accelerator: trade name “Octope Zn” [Zn 2-ethylhexanoate], manufactured by Hope Chemical Co., Ltd.

### (C-4)

Photopolymerization initiator: trade name “Omnirad 184” [1-hydroxy cyclohexylphenyl ketone], manufactured by IGM Resins B. V.

### (A2) Curing Agent

### (D-1)

Acid-anhydride-based curing agent: trade name “HN-5500” [3(4)methyl-hexahydrophthalic anhydride], manufactured by Hitachi Chemical Co., Ltd.

### (D-2)

Amine-based curing agent: trade name “KAYAHARD AA” [diethyldiaminodiphenylmethane], Nippon Kayaku Co., Ltd.

### Example 1

As the component (A1), 30 parts of (A-1), as the component (B), 10 parts of (B-1), and as the component (C), 0.1 part of (C-2) were mixed, and then kneaded by stirring for 5 minutes and defoaming for 2 minutes by using a planetary centrifugal stirring apparatus (trade name “THINKY MIXER”: ARE-310, manufactured by THINKY CORPORATION) to obtain a silicone hybrid resin composition, being a homogeneous white liquid.

### Example 2

As the component (A1), 30 parts of the component (A-1), and as the component (B), 30 parts of (B-1) were kneaded by stirring for 10 minutes and defoaming for 2 minutes at 100° C. by using a planetary centrifugal stirring apparatus. After the mixture was returned to a normal temperature, 0.1 part of (C-1) as the component (C) and (D-1) as the component (A2) were mixed. (D-1) was mixed in such an amount that the proportion of the total number of acid anhydrides in the component (D) relative to the total number of epoxy groups in the component (A) was 1.0. Thus, a silicone hybrid resin composition, being a homogeneous white liquid was obtained.

### Example 3

A composition was prepared in the same manner as in Example 2 except that the component (D-1) used in Example 2 was changed to the component (D-2), and that (C-1) was not added. Thus, a silicone hybrid resin composition, being a homogeneous white liquid was obtained. In the preparation, the component (D-2) was blended in such an amount that the proportion of the total number of amino groups in the component (A2) relative to the total number of epoxy groups in the component (A1) was 1.0.

### Example 4

As the component (A1), 30 parts of (A-2), and as the component (A2), (D-1) was mixed in such an amount that the proportion of the total number of acid anhydrides in the component (A2) relative to the total number of epoxy groups in the component (A1) was 1.0.0.1 part of water was dropped thereto, and the mixture was stirred at 100° C. for 3 hours. Subsequently, 30 parts of the component (B-1) was dropped thereto as the component (B) and stirred for 30 minutes, and then 0.1 part of (C-1) was mixed as the component (C) to obtain a silicone hybrid resin composition, being a homogeneous white solid.

### Example 5

As the component (A1), 25 parts of (A-3) and 5 parts of (A-4), as the component (B), 10 parts of (B-1), and as the component (C), 0.1 part of (C-2) were mixed, and kneaded by stirring for 5 minutes and defoaming for 2 minutes by using a planetary centrifugal stirring apparatus to obtain a silicone hybrid resin composition, being a homogeneous white liquid.

### Example 6

A composition was prepared in the same manner as in Example 1, except that the component (B-1) used in Example 1 was changed to (B-2). Thus, a silicone hybrid resin composition, being a homogeneous milky-white translucent liquid was obtained.

### Example 7

A composition was prepared in the same manner as in Example 1, except that the component (B-1) used in Example 1 was changed to the component (B-3). Thus, a silicone hybrid resin composition, being a homogeneous white liquid was obtained.

### Example 8

A composition was prepared in the same manner as in Example 1, except that the component (B-1) used in Example 1 was changed to the component (B-4). Thus, a silicone hybrid resin composition, being a homogeneous white liquid was obtained.

### Example 9

As the component (A1), 30 parts of (A-5), as the component (B), 10 parts of (B-4), and as the component (C), 0.1 part of (C-3) were mixed, and then kneaded by stirring for 5 minutes and defoaming for 2 minutes by using a planetary centrifugal stirring apparatus to obtain a silicone hybrid resin composition, being a homogeneous reddish brown liquid.

### Example 10

As the component (A1), 30 parts of (A-6), and as the component (B), 10 parts of (B-1) were kneaded by stirring for 10 minutes and defoaming for 2 minutes at 100° C. by using a planetary centrifugal stirring apparatus. After the mixture was returned to a normal temperature, 0.1 part of (C-4) was mixed as the component (C) to obtain a silicone hybrid resin composition, being a homogeneous white liquid.

### Example 11

As the component (A1), 28 parts of (A-1) and 2 parts of (A-3), as the component (B), 15 parts of (B-7), and as the component (C), 0.1 part of (C-2) were mixed, and then kneaded by stirring for 5 minutes and defoaming for 2 minutes by using a planetary centrifugal stirring apparatus to obtain a silicone hybrid resin composition, being a homogeneous white liquid.

### Example 12

As the component (A1), 15 parts of (A-1) and 15 parts of (A-3), and as the component (B), 30 parts of (B-2) were kneaded by stirring for 10 minutes and defoaming for 2 minutes at 100° C. by using a planetary centrifugal stirring apparatus. After the mixture was returned to a normal temperature, 0.1 of (C-1) as the component (C) and (D-1) as the component (A2) were mixed. (D-1) was mixed in such an amount that the proportion of the total number of acid anhydrides in the component (A2) relative to the total number of epoxy groups in the component (A1) was 1.0. The mixture was kneaded by stirring for 5 minutes and defoaming for 2 minutes by using a planetary centrifugal stirring apparatus to obtain a silicone hybrid resin composition, being homogeneous, colorless, and transparent.

### Example 13

A composition was prepared in the same manner as in Example 2, except that the component (A-1) used in Example 2 was changed to the component (A-3). Thus, a silicone hybrid resin composition, being a homogeneous white liquid was obtained.

### Comparative Example 1

A composition was prepared in the same manner as in Example 1, except that the component (B-1) used in Example 1 was not added.

### Comparative Example 2

A composition was prepared in the same manner as in Example 2, except that the component (B-1) used in Example 2 was not added.

### Comparative Example 3

A composition was prepared in the same manner as in Example 1, except that 5 parts of the component (B-5) were used instead of the component (B-1) used in Example 1.

### Comparative Example 4

A composition was prepared in the same manner as in Example 1, except that 30 parts of the component (B-5) were used instead of the component (B-1) used in Example 1. The obtained composition was semi-solid.

### Comparative Example 5

As the component (A1), 30 parts of (A-3), as the component (B), 30 parts of (B-6), and as the component (C), 0.1 part of (C-2) were mixed, and then kneaded by stirring for 5 minutes and defoaming for 2 minutes by using a planetary centrifugal stirring apparatus to obtain a silicone hybrid resin composition, being a homogeneous milky-white translucent liquid.

### Comparative Example 6

A composition was prepared in the same manner as in Example 10, except that 30 parts of the component (B-3) were used instead of the component (B-1) used in Example 10.

### Comparative Example 7

A composition was prepared in the same manner as in Example 10, except that the component (B-1) used in Example 10 was not added.

Physical properties of the compositions prepared in Examples 1 to 13 and Comparative Examples 1 to 7 and cured materials thereof were assessed by the following methods. Tables 1 and 2 show the results.

Among the silicone hybrid resin compositions, in Examples 1, 5 to 8, 10, and 11, and Comparative Examples 1 and 3 to 7, in which the component (C-2) or the component (C-4) was used, a cured material of each composition was obtained in the following manner. That is, each composition was irradiated with an ultraviolet ray for 2 seconds at an illuminance of 40 W/cm² in a conveyor furnace equipped with two metal halide mercury lamps, and then cured at 150° C. for 4 hours. Regarding the other Examples and Comparative Examples, the cured material of each composition was obtained by curing at 150° C. for 4 hours.

### (1) Properties

The flowability of each composition before curing was observed. 50 g of the composition was added to a 100-ml glass jar, and the glass jar was placed on its side and left to stand at 25° C. for 10 minutes. If the resin flowed out in that time, the composition was judged to be liquid.

### (2) Viscosity

The viscosity of each composition at 25° C. before curing was measured by the method described in JIS K 7117-1:1999. Note that in Example 4, the composition was solid, and in Comparative Example 4, the composition was semi-solid, and therefore, viscosity was not measured.

### (3) Hardness (Type D)

The hardness of the cured material cured in the above manner was measured with a durometer type D hardness tester in accordance with JIS K 6249:2003.

### (4) Adhesive Properties

Onto a copper plate with an area of 180 mm², 0.25 g of each composition was molded so as to have a base area of 45 mm², and cured by the above method to fabricate a test piece for adhesion. The shearing adhesive force of the test piece was measured at 25° C. by using a bond tester DAGE-SERIES-4000PXY (manufactured by DAGE Co., Ltd.). After the adhesiveness test, the ratio of a part of cohesive failure and a part of delamination was determined to judge the adhesive properties (failure mode).

### (Criterion for Judging)

Good:adhesive properties were favorable (the ratio of cohesive failure was 80% or more)

Bad:adhesive properties were poor (the ratio of cohesive failure was less than 80%)

### (5) Dispersibility

A broken surface of the cured material of each composition was observed with an electron microscope, and the maximum domain size was measured by visual evaluation. In addition, if the dispersibility of the component (A) (the component (A1) and the component (A2)) was favorable, the composition was judged as “Good”, and if the dispersibility was poor, the composition was judged as “Bad”. Note that dispersibility was not evaluated in Comparative Examples 1, 2, and 7 since the component (B) was not added, and dispersibility was not evaluated in Comparative Example 6 since the component (B) was made homogeneously compatible.

### (6) Thermal Shock Resistance

The test piece used in the adhesiveness test was subjected to a thermal shock test using a liquid to liquid thermal shock tester (manufactured by ESPEC Corp.) at −40° C. to 120° C. over 1,000 cycles. After the test, an adhesiveness test was carried out under the same conditions as above. After the adhesiveness test, the ratio of a part of cohesive failure and a part of delamination was determined to judge the adhesive properties.

### (Criterion for Judging)

Good: adhesive properties were favorable (the ratio of cohesive failure was 80% or more)

Bad: adhesive properties were poor (the ratio of cohesive failure was less than 80%)

### (7) Impact Resistance Test

A steel ball of 43 g was dropped onto a cured material (50 mm×50 mm×2 mm) of each composition from a height of 1 m, and the cured material was observed for damage.

### (Criterion for Judging)

Good: the cured material maintained the form of a sheet

Bad: the cured material was broken and damaged

### (8) Storage Modulus and Glass-Transition Temperature

A cured material (10 mm×15 mm×1 mm) of each silicone hybrid resin composition was prepared, a test piece of each cured material was set in a dynamic mechanical analyzer Q-800 (manufactured by Kitahama Seisakusho Co., Ltd.), and the storage modulus and Tan δ of each resin composition was measured between 25° C. and 300° C. The temperature at which the storage modulus and Tan δ at a normal temperature 25° C. exhibit a maximum value was taken as a glass-transition temperature.

The results of the above are shown in Table 1 and Table 2.

TABLE 1

| Example | | 1 | 2 | 3 | 4 | 5 | 6 | 7 | 8 | 9 | 10 | 11 | 12 | 13 |
|---|---|---|---|---|---|---|---|---|---|---|---|---|---|---|
| Curable organic | | 30 | 30 | 30 | | | 30 | 30 | 30 | | | 28 | 15 | |
| resin (A-1) | | | | | | | | | | | | | | |
| Curable organic | | | | | 30 | | | | | | | | | |
| resin (A-2) | | | | | | | | | | | | | | |
| Curable organic | | | | | | 25 | | | | | | 2 | 15 | 30 |
| resin (A-3) | | | | | | | | | | | | | | |
| Curable organic | | | | | | 5 | | | | | | | | |
| resin (A-4) | | | | | | | | | | | | | | |
| Curable organic | | | | | | | | | | 30 | | | | |
| resin (A-5) | | | | | | | | | | | | | | |
| Curable organic | | | | | | | | | | | 30 | | | |
| resin (A-6) | | | | | | | | | | | | | | |
| Curable silicone | | 10 | 30 | 30 | 30 | 10 | | | | | 10 | | | 30 |
| resin composition | | | | | | | | | | | | | | |
| (B-1) | | | | | | | | | | | | | | |
| Curable silicone | | | | | | | 10 | | | | | | 30 | |
| resin composition | | | | | | | | | | | | | | |
| (B-2) | | | | | | | | | | | | | | |
| Curable silicone | | | | | | | | 10 | | | | | | |
| resin composition | | | | | | | | | | | | | | |
| (B-3) | | | | | | | | | | | | | | |
| Curable silicone | | | | | | | | | 10 | 10 | | | | |
| resin composition | | | | | | | | | | | | | | |
| (B-4) | | | | | | | | | | | | | | |
| Curable silicone | | | | | | | | | | | | | | |
| resin composition | | | | | | | | | | | | | | |
| (B-5) | | | | | | | | | | | | | | |
| Curable silicone | | | | | | | | | | | | | | |
| resin composition | | | | | | | | | | | | | | |
| (B-6) | | | | | | | | | | | | | | |
| Curable silicone | | | | | | | | | | | | 15 | | |
| resin composition | | | | | | | | | | | | | | |
| (B-7) | | | | | | | | | | | | | | |
| Curing accelerator | | | 0.1 | | 0.1 | | | | | | | | 0.1 | 0.1 |
| (C-1) | | | | | | | | | | | | | | |
| Curing accelerator | | 0.1 | | | | 0.1 | 0.1 | 0.1 | 0.1 | | | 0.1 | | |
| (C-2) | | | | | | | | | | | | | | |
| Curing accelerator | | | | | | | | | | 0.1 | | | | |
| (C-3) | | | | | | | | | | | | | | |
| Curing accelerator | | | | | | | | | | | 0.1 | | | |
| (C-4) | | | | | | | | | | | | | | |
| Curing agent (D-1) | | | 1.0eq | | 1.0eq | | | | | | | | 1.0eq | 1.0eq |
| Curing agent (D-2) | | | | 1.0eq | | | | | | | | | | |
| Properties | | Liquid | Liquid | Liquid | Solid | Liquid | Liquid | Liquid | Liquid | Liquid | Liquid | Liquid | Liquid | Liquid |
| Viscosity (Pa · s) | | 12 | 4 | 16 | — | 12 | 6 | 10 | 15 | 2.5 | 6 | 10 | 3 | 5 |
| Appear- | Color | White | White | White | White | White | Milky- | White | White | Reddish | White | White | Colorless | White |
| ance of | tone | | | | | | white | | | brown | | | | |
| cured | Trans- | Opaque | Opaque | Opaque | Opaque | Opaque | Trans- | Opaque | Opaque | Opaque | Opaque | Opaque | Trans- | Opaque |
| material | parency | | | | | | lucent | | | | | | parent | |
| Dispersibility | | Good | Good | Good | Good | Good | Good | Good | Good | Good | Good | Good | Good | Good |
| Domain size (μm) | | 2 | 1 | 3 | 20 | 1 | 2 | 5 | 3 | 5 | 2 | 3 | 1 | 1 |
| Hardness (type D) | | 75 | 65 | 67 | 70 | 75 | 73 | 72 | 76 | 80 | 55 | 65 | 68 | 63 |
| Storage modulus | | 1500 | 850 | 1000 | 1100 | 1600 | 1650 | 1600 | 1600 | 2300 | 300 | 820 | 900 | 650 |
| (MPa) | | | | | | | | | | | | | | |
| Glass-transition | | 140 | 145 | 135 | 180 | 145 | 140 | 140 | 142 | 250 | 70 | 140 | 145 | 140 |
| temperature (° C.) | | | | | | | | | | | | | | |
| Shearing | Initial | 8.8 | 4.3 | 5.6 | 6.2 | 7.3 | 10.8 | 9.9 | 9.2 | 13.2 | 3.5 | 5.6 | 8.9 | 6.5 |
| adhesive | After | 7.9 | 4.5 | 5.1 | 6.4 | 7.1 | 10.5 | 10.1 | 9.6 | 12.4 | 3.7 | 6.1 | 9.1 | 6.4 |
| force | thermal | | | | | | | | | | | | | |
| (kg/mm2) | shock | | | | | | | | | | | | | |
| | test | | | | | | | | | | | | | |
| Failure | Initial | Good | Good | Good | Good | Good | Good | Good | Good | Good | Good | Good | Good | Good |
| mode | After | Good | Good | Good | Good | Good | Good | Good | Good | Good | Good | Good | Good | Good |
| | thermal | | | | | | | | | | | | | |
| | shock | | | | | | | | | | | | | |
| | test | | | | | | | | | | | | | |
| Shock | Resin | Good | Good | Good | Good | Good | Good | Good | Good | Good | Good | Good | Good | Good |
| test | cracks | | | | | | | | | | | | | |

TABLE 2

| Comparative Example | | 1 | 2 | 3 | 4 | 5 | 6 | 7 |
|---|---|---|---|---|---|---|---|---|
| Curable organic resin (A-1) | | 30 | 30 | 30 | 30 | | | |
| Curable organic resin (A-2) | | | | | | | | |
| Curable organic resin (A-3) | | | | | | 30 | | |
| Curable organic resin (A-4) | | | | | | | | |
| Curable organic resin (A-5) | | | | | | | | |
| Curable organic resin (A-6) | | | | | | | 30 | 30 |
| Curable silicone resin | | | | | | | | |
| composition (B-1) | | | | | | | | |
| Curable silicone resin | | | | | | | | |
| composition (B-2) | | | | | | | | |
| Curable silicone resin | | | | | | | 30 | |
| composition (B-3) | | | | | | | | |
| Curable silicone resin | | | | | | | | |
| composition (B-4) | | | | | | | | |
| Curable silicone resin | | | | 5 | 30 | | | |
| composition (B-5) | | | | | | | | |
| Curable silicone resin | | | | | | 30 | | |
| composition (B-6) | | | | | | | | |
| Curing accelerator (C-1) | | | 0.1 | | | | | |
| Curing accelerator (C-2) | | 0.1 | | 0.1 | 0.1 | 0.1 | | |
| Curing accelerator (C-3) | | | | | | | | |
| Curing accelerator (C-4) | | | | | | | 0.1 | 0.1 |
| Curing agent (D-1) | | | 1.0eq | | | | | |
| Curing agent (D-2) | | | | | | | | |
| Properties | | Liquid | Liquid | Liquid | Semi- | Liquid | Liquid | Liquid |
| | | | | | solid | | | |
| Viscosity (Pa · s) | | 11 | 0.3 | 150 | — | 6 | 2.8 | 1.2 |
| Appearance | Color tone | Colorless | Colorless | White | White | Milky- | Pale | Pale |
| of cured | | | | | | white | yellow | yellow |
| material | Transparency | Trans- | Trans- | Opaque | Opaque | Trans- | Trans- | Trans- |
| | | parent | parent | | | lucent | parent | parent |
| Dispersibility | | — | — | Good | Bad | Good | — | — |
| Domain size (μm) | | — | — | 10 | 10 | 1 | — | |
| Hardness (type D) | | 85 | 85 | 75 | — | 75 | 30 | 75 |
| Storage modulus (MPa) | | 2400 | 2600 | 1500 | — | 1600 | 300 | 2000 |
| Glass-transition temperature | | 140 | 145 | 140 | — | 95 | 20 | 75 |
| (° C.) | | | | | | | | |
| Shearing | Initial | 7.4 | 8.4 | 7.5 | — | 6.3 | 2.1 | 8.5 |
| adhesive | After thermal | 1.9 | 2.5 | 6.9 | — | 7.1 | 1.2 | 6.9 |
| force | shock test | | | | | | | |
| (kg/mm2) | | | | | | | | |
| Failure | Initial | Bad | Bad | Good | — | Bad | Bad | Bad |
| mode | After thermal | Bad | Bad | Bad | — | Bad | Bad | Bad |
| | shock test | | | | | | | |
| Shock test | Resin cracks | Bad | Bad | Bad | — | Bad | Good | Bad |

As shown in Table 1, in Examples 1 to 13, in which the inventive silicone hybrid resin composition was used as the component (A1), component (B), component (C), and component (A2), a composition that was generally white and had sufficient viscosity was obtained. In addition, the composition was cured to obtain a cured material that was generally white and opaque, and was excellent in dispersibility, Tg, and adhesive properties. On the contrary, in Comparative Examples 1, 2, and 7, in which the component (B) was not added, the failure mode of the adhesiveness was delamination, and adhesiveness was poor. Furthermore, in Comparative Example 3, in which silicone rubber particles that do not satisfy the requirements of the viscosity of the present invention were added as the component (B), viscosity increased, and workability and impact resistance were degraded. Similarly, in Comparative Example 4, in which silicone rubber particles were added as the component (B), viscosity was too high to produce a sample, and dispersibility was also degraded. Meanwhile, in Comparative Example 5, in which epoxy-modified silicone resins were used as the component (A) and the component (B) and cured by the same reaction mechanism, the Tg was greatly lowered, and the failure mode of the adhesiveness was delamination. In addition, in Comparative Example 6, in which the component (A) and the component (B) cure by the same photo-radical reaction, domains were not observed since the component (A) and the component (B) were homogeneously compatible, the Tg was greatly lowered, and the failure mode of the adhesiveness was delamination.

As described above, the inventive silicone hybrid resin composition can give a cured material that exhibits excellent adhesive properties and thermal shock resistance.

It should be noted that the present invention is not limited to the above-described embodiments. The embodiments are just examples, and any examples that have substantially the same feature and demonstrate the same functions and effects as those in the technical concept disclosed in claims of the present invention are included in the technical scope of the present invention.

1. A silicone hybrid resin composition comprising:
(A) 100 parts by mass of a curable organic resin composition comprising (A1) one or more curable organic resins selected from a group consisting of an epoxy resin, an acrylic resin, a polyimide resin, a maleimide resin, a polyurethane resin, a phenolic resin, a melamine resin, and silicone-modified resins thereof; and
(B) 1 to 300 parts by mass of a curable silicone resin composition having a viscosity at 25° C. of 0.01 to 1,000 Pa·s as measured by a method described in JIS K 7117-1:1999,
wherein the component (B) is a dispersion in the component (A), and the component (A) is a curable organic resin composition that cures by a reaction mechanism that is different from a reaction mechanism of the component (B).

2. The silicone hybrid resin composition according to claim 1, wherein the component (B) has a domain size of 100 μm or less.

3. The silicone hybrid resin composition according to claim 1, wherein the component (B) is a curable silicone resin composition selected from an addition-curable silicone resin composition, a condensation-curable silicone resin composition, and a radical-curable silicone resin composition.

4. The silicone hybrid resin composition according to claim 2, wherein the component (B) is a curable silicone resin composition selected from an addition-curable silicone resin composition, a condensation-curable silicone resin composition, and a radical-curable silicone resin composition.

5. The silicone hybrid resin composition according to claim 1, wherein the component (A1) is an epoxy resin and/or a silicone-modified epoxy resin.

6. The silicone hybrid resin composition according to claim 2, wherein the component (A1) is an epoxy resin and/or a silicone-modified epoxy resin.

7. The silicone hybrid resin composition according to claim 3, wherein the component (A1) is an epoxy resin and/or a silicone-modified epoxy resin.

8. The silicone hybrid resin composition according to claim 4, wherein the component (A1) is an epoxy resin and/or a silicone-modified epoxy resin.

9. The silicone hybrid resin composition according to claim 1, further comprising (C) 0.001 to 10 parts by mass of a curing accelerator of the component (A).

10. The silicone hybrid resin composition according to claim 2, further comprising (C) 0.001 to 10 parts by mass of a curing accelerator of the component (A).

11. The silicone hybrid resin composition according to claim 3, further comprising (C) 0.001 to 10 parts by mass of a curing accelerator of the component (A).

12. The silicone hybrid resin composition according to claim 4, further comprising (C) 0.001 to 10 parts by mass of a curing accelerator of the component (A).

13. The silicone hybrid resin composition according to claim 1, wherein the component (A) further comprises (A2) a curing agent of the component (A1) in an amount such that there are, based on a total of 1 equivalent of a curing-reactive group in the component (A1), 0.3 to 2.0 equivalents of a group in the component (A2), the group having reactivity to the curing-reactive group.

14. The silicone hybrid resin composition according to claim 2, wherein the component (A) further comprises (A2) a curing agent of the component (A1) in an amount such that there are, based on a total of 1 equivalent of a curing-reactive group in the component (A1), 0.3 to 2.0 equivalents of a group in the component (A2), the group having reactivity to the curing-reactive group.

15. The silicone hybrid resin composition according to claim 3, wherein the component (A) further comprises (A2) a curing agent of the component (A1) in an amount such that there are, based on a total of 1 equivalent of a curing-reactive group in the component (A1), 0.3 to 2.0 equivalents of a group in the component (A2), the group having reactivity to the curing-reactive group.

16. The silicone hybrid resin composition according to claim 4, wherein the component (A) further comprises (A2) a curing agent of the component (A1) in an amount such that there are, based on a total of 1 equivalent of a curing-reactive group in the component (A1), 0.3 to 2.0 equivalents of a group in the component (A2), the group having reactivity to the curing-reactive group.

17. The silicone hybrid resin composition according to claim 1, wherein the component (B) cures before the component (A).

18. The silicone hybrid resin composition according to claim 2, wherein the component (B) cures before the component (A).

19. A semiconductor device comprising a cured material of the silicone hybrid resin composition according to claim 1.

20. A semiconductor device comprising a cured material of the silicone hybrid resin composition according to claim 2.
